(19) United States
(12) Patent Application Publication
(10) Pub. No.: US 2023/0364774 A1
(43) Pub. Date: Nov. 16, 2023

(54) SYSTEM AND METHOD OF ORGANIZING A SET OF TOOLS

(71) Applicant: Bill Rzadkowolski, Oxford, MI (US)

(72) Inventor: Bill Rzadkowolski, Oxford, MI (US)

(21) Appl. No.: 18/313,797

(22) Filed: May 8, 2023

Related U.S. Application Data
(60) Provisional application No. 63/340,197, filed on May 10, 2022.

(51) Int. Cl. B25G 1/10

(52) U.S. Cl. CPC B25G 1/10

(57) ABSTRACT

A system and method of organizing a set of tools may include a plurality of sleeves for receiving a plurality of tools. Each sleeve may be formed from a heat-shrinkable material. Each sleeve may include a discriminator unique to that sleeve so that a tool of the set of tools may be easily identified and grasped by a user when needed.

### CROSS-REFERENCE TO RELATED APPLICATIONS

This application claims the benefit of U.S. Provisional Application No. 63/340,197 filed on May 10, 2022. The entire disclosure of the above application is incorporated herein by reference.

### FIELD

The present disclosure relates to system for organizing a set of tools and, more particularly, a tool sleeves kit and method for organizing a tool kit.

### INTRODUCTION

The statements in this section merely provide background information related to the present disclosure and may not constitute prior art.

The average workshop may contain many tool sets. Tool sets come in hundreds of varieties of types, systems, and sizes of tools. For example, sockets come in dozens of sizes and a socket set may include standard, semi-deep, and deep sockets for any size. Additionally, wrenches alone come in the open ended, box, combination, adjustable, hex, socket, and torque varieties. Further, wrenches may come in either metric or SAE sizes that range from 8 mm to 50 mm and ¼ inch to 2 inches, respectively.

Furthermore, tools created by the same company typically have identical handles or handle grips. For example, if a user is loyal to a specific tool brand, their hammers, wrenches, screwdrivers, and pliers may have the same color handles. Additionally, tools that are not labeled with branding are typically all metal.

With the ability to have so many different sockets and tools in a single workshop, sockets and tools may quickly become disorganized. This disorganization can lead to the user searching repeatedly for specific sockets and tools, resulting in wasted time. Although most sockets and tool handles are labeled with sizes, this system of organizing does not save the user time because the user must look at every socket or tool handle marking to identify the type and size of the socket or tool. Additionally, labeling on sockets and tool handles is typically very small and difficult to read. This can cause problems for older people and visually impaired people.

Accordingly, there is a continuing need for an easy to apply system and method for organizing a set of tools.

### SUMMARY

In concordance with the instant disclosure an easy to apply system and method for organizing a set of tools has been surprisingly discovered.

Various embodiments of the invention relate to a system for organizing a set of tools. In certain embodiments, the system may include a plurality of sleeves. Each sleeve may be formed of a heat-shrinkable material and include a discriminator unique to that sleeve. The discriminator may include a member selected from a group consisting of an indicium, a color, a texture, and combinations thereof.

In certain embodiments, the discriminator may include an indicium. Alternatively, or in combination, the discriminator may include a color or a texture. The sleeve may have a diameter greater than a length of the sleeve. Alternatively, each sleeve may have a diameter less than a length of the sleeve.

In certain embodiments, each sleeve may have a diameter substantially equal to a length of the sleeve. The plurality of sleeves may include differently sized sleeves. The plurality of sleeves may include sleeves having different diameters and sleeves including different lengths. In certain embodiments, the plurality of sleeves may be coupled to a chain. Each sleeve may depend from the chain or otherwise be co-formed with the chain.

A set of tools may include a plurality of tools. Each tool may include a geometric parameter unique to that tool and a heat-shrunk sleeve disposed thereon. The heat-shrunk sleeve may include a discriminator unique to the sleeve. In certain embodiments, at least one of the tools may include more than one heat-shrunk sleeve disposed thereon. The set of tools may include a member selected from a group consisting of a set of sockets, a set of wrenches, and a set of hand tools. However, as would be understood by someone of ordinary skill in the art, the set of tools may include any appropriately desired tools.

A method of organizing a set of tools may include providing a plurality of tools. Each tool may include a geometric parameter unique to that tool. A plurality of sleeves formed of a heat-shrinkable material may include a discriminator unique to that sleeve. The method may also include disposing a sleeve on one of the tools. The sleeve may be heat shrunk onto one of the tools. The disposing step and the heat-shrinking step may be repeated for the entirety of the plurality of tools and the entirety of the plurality of sleeves. In certain embodiments, the sleeves may be disposed onto the plurality of tools in a sequential manner. Alternatively, or in conjunction, the sleeves may be disposed onto the plurality of the tools in a sequential manner.

In certain embodiments, the disposing step may include disposing two of the sleeves on one of the tools and the heat-shrinking step may include heating-shrinking the two sleeves on the tool. The method may further include removing a first sleeve from a chain before heating the first sleeve and removing a second sleeve from the chain before heating the second sleeve.

A set of sleeves, such as a set of shrink wrap sleeves may be brightly color coded. Additionally, large contrasting lettering may be used on the tool set. The sleeves may also be textured and untextured. A shrink wrap sleeve may be slid over the handle of a tool and heated to form to the shape of the tool handle. Varying colors and textures of sleeves may allow a user to quickly identify a tool and also clean up the appearance of the tool set. A sleeve may be used to create a shrink wrap sleeve organizational system in which indicium, colors, and textures of the shrink wrap sleeve allows the user to quickly identify each tool or tool family.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a block diagram illustrating a system for organizing a set of tools, according to an embodiment of the present disclosure.

FIG. 2 is a front elevational view illustrating a system for organizing a set of tools, according to an embodiment of the present disclosure.

FIG. 3 is a front elevational view illustrating a system for organizing a set of tools, according to an embodiment of the present disclosure.

FIG. 4 is a front elevational view illustrating a set of sleeves disposed onto a chain for organizing a set of tools, according to an embodiment of the present disclosure.

FIG. 5 is a top plan view illustrating a continuous tube and bag for organizing a set of tools, according to an embodiment of the present disclosure.

FIG. 6 is a flowchart illustrating a method of organizing a set of tools, according to an embodiment of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a process reciting elements A, B and C specifically envisions embodiments consisting of, and consisting essentially of, A, B and C, excluding an element D that may be recited in the art, even though element D is not explicitly described as being excluded herein.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature’s relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology relates to a sleeve and a set of sleeves that may be used to identify a tool within a set of tools, such as a socket tool set and a wrench set. The sleeve may be color coded, have contrasting lettering, and/or a texture to identify a size and/or a characteristic of the tool. The texture may further allow a user to securely grip or hold the tool. In certain embodiments, the sleeve may be slid over a handle of a tool and be heated to conform to a shape of the handle or other portion of the tool. The sleeve allows a user to quickly identify a tool without using it and may also protect the tool during use and when the tool is being stored. In certain embodiments, the sleeve may identify a metric tool or an imperial tool. In particular, the sleeve may enable a user to quickly identify a tool and/or a series of tools. In certain embodiments, a sleeve may be pre-printed and precut such that the sleeve may be installed with a simple heat source. In certain embodiments, a sleeve may be easily removed with no damage to tools.

In certain embodiments, the plurality of sleeves may include a first sleeve having a first diameter and a second sleeve having a second diameter. The first diameter may be different from the second diameter. Each sleeve of the plurality of sleeves may be made from a heat shrinkable material or other appropriately desired material configured to be applied to a plurality of tools in a tool set in order to identify the tools within the tool set. For example, a sleeve may be formed using polyethylene terephthalate glycol or polyvinyl chloride. However, it should be appreciated that one skilled in the art may manufacture a sleeve from other materials as appropriately desired.

In certain embodiments, a diameter of a first sleeve may be between ¼ inch, and 1 inch and a diameter of a second sleeve may be between 5/16 inch and 1 inch or between ⅜ inch and 1 inch. Alternatively, a diameter of the first sleeve may be between 8 mm and 24 mm and a diameter of a second sleeve may be between 10 mm and 24 mm. In particular, a diameter and/or size and length of the sleeve may include any appropriately desired size.

A sleeve may include a thickness between about 6 mil and about 12 mil. Advantageously, a sleeve thickness between about 6 mil and about 12 mil may allow the plurality of tools to fit into a designated groove for storing in a tool set. In another embodiment, each of the plurality of sleeves may have a thickness between about 20 mil and about 40 mil. Advantageously, a sleeve thickness between about 20 mil and about 40 mil may allow a tool to have a sleeve configured to each tool handle. Each sleeve may further protect a tool from rust and aging. However, it should be appreciated that other thicknesses of sleeves may be utilized as appropriately desired.

A length of a sleeve may be proportional to a length of the tool. For example, the tool may be a socket and the length of the sleeve may correspond to the length of the socket. It should be appreciated that a length of each sleeve may not extend beyond the length of the tool. In particular, in certain embodiments, the length of the sleeve may be equal to or shorter than 3 inches. In certain embodiments, the tool may include a wrench and, where a length of the sleeve corresponds to a length of the wrench handle. In certain embodiments, the length of the sleeve does not extend beyond a handle of the wrench. Therefore, where the tool comprises a wrench, the length of the sleeve may be equal to or shorter than about 5 inches. In particular, the sleeve length may be adjusted as appropriately desired to fit a tool.

Each sleeve may include an appropriately desired color. For example, a first sleeve may include a first color and a second sleeve may include a second color, different from the first color. Advantageously, the colors of the sleeves may be ordered to signify a size of a tool within the tool set. As another non-limiting example, the sleeves may include varying shades of a same color wherein a darker shade denotes a larger tool size. One of ordinary skill may also select other suitable colors for a sleeve, as appropriately desired.

Each sleeve may also or alternatively include a texture. For example, a first sleeve may include a first texture and second sleeve may include a second texture, different from the first texture. In certain embodiments, the texture may indicate a size of the tool, a type of the tool, or the system of a tool. The texture may include any texture as appropriately desired for indicating a size or characteristic of the tool.

In certain embodiments, a sleeve may include an indicium or marking. For example, a first sleeve may include a first marking and a second sleeve may include a second marking, different from the first marking. The first marking and the second marking may indicate a size or other characteristic of the tool. In particular, the marking may include any appropriately desired marking for identifying a tool.

In certain embodiments, each sleeve may be brightly color coded and comprise large contrasting lettering. The sleeves may also be textured or untextured. A sleeve may be slid over the handle of the tool and heated to form a shape of the tool handle. The colors and textures of a sleeve may allow a user to quickly identify a tool and also protect and provide a clean appearance for a tool set. A sleeve may be used to create an organizational system in which an indicium, a color, and/or a texture of the sleeve allows a user to quickly identify each tool or tool family.

Advantageously, the system and method of organizing a tool set may allow a user to better organize a tool set based on easily identifiable indicia such as a plurality of colors, a plurality of textures, and/or a plurality of tool markings or indicium. A method of organizing a tool set may allow a user to work quickly.

Example embodiments of the present technology are provided with reference to the several figures enclosed herewith.

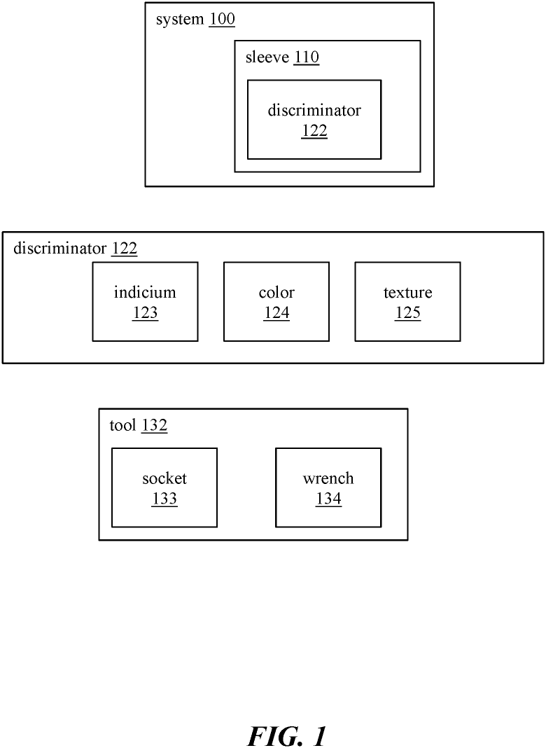

FIGS. 1 - 4 show embodiments of a system 100 for organizing a set of tools. The system 100 may include a plurality of sleeves 110. Each sleeve 110 may be formed of a heat-shrinkable material. The sleeve 110 may include a discriminator 122 unique to that sleeve. The discriminator 122 may include an indicium 123, a color 124, a texture 125, and combinations thereof. In particular, the discriminator 122 may include any appropriately desired indicium 123, color 124, texture 125 and/or combination of features for identifying a tool.

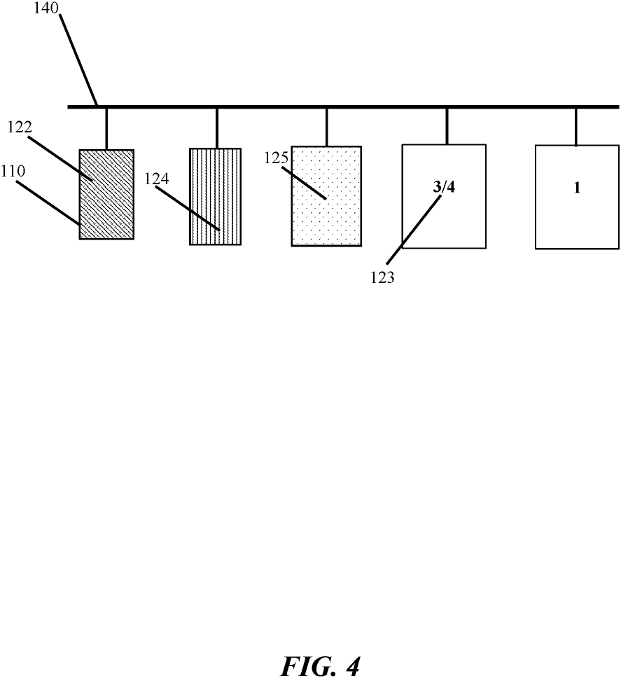

Each sleeve 110 may be a differently sized or differently shaped sleeve 110 for accepting a particularly sized tool 132. In certain embodiments, such as shown in FIG. 4, each sleeve 110 may be coupled to a chain 140. In particular, each sleeve may depend from the chain 140. The sleeve 110 may be co-formed with the chain 140. The chain 140 can keep the sleeves 110 together and prevent loss until the sleeve(s) is/are to be installed on respective tools 132. The sleeves 110 can also be formed from a continuous sleeve that is precut, perforated, stamped, and/or printed with texture, indicia, and the like to thereby form the chain 140 of separable sleeves 110. Various methods, molds, and extrusion techniques can be selected to form the sleeves 110 and the chain 140 of sleeves. The chain 140 holding the sleeves 110 can include one or more sprues or runners from an injection molding process. Alternatively, the sleeves 110 can be formed from a continuous tube of material that is precut, perforated, stamped, and/or printed with texture, indicia, and the like.

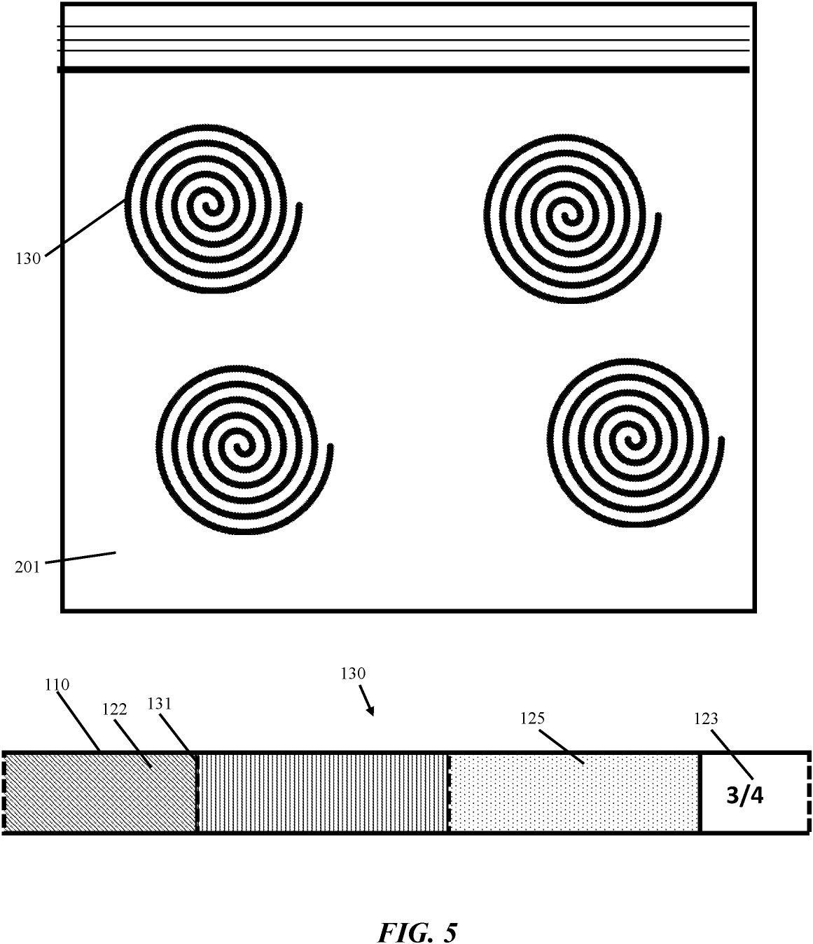

As shown in FIG. 5, in certain embodiments, a sleeve 110 may be formed as a continuous tube 130. The continuous tube 130 may include sleeve defining elements bounding each of the sleeves 110. Each sleeve defining element may include one or more of an indicium 123, a texture 125, and combinations thereof. The continuous tube 130 may be precut and/or include a perforation 131 so that the continuous tube 130 may be torn or cut to define a sleeve 110. In certain embodiments, each perforation 131 may be uniform along a length of the continuous tube 130 so that the continuous tube 130 may be torn to create uniform sleeves 110. In certain embodiments, a user may tear the continuous tube 130 at a desired length. For example, the continuous tube 130 may be torn at 1 inch to fit a socket and torn at 5 inches to fit the ratchet handle 135. In certain embodiments, the continuous tube 130 may include non-uniform perforations and/or cutting marks for differently sized sleeves 110. In certain embodiments, a continuous tube 130 may be rolled and stored in a bag 201 for easy use.

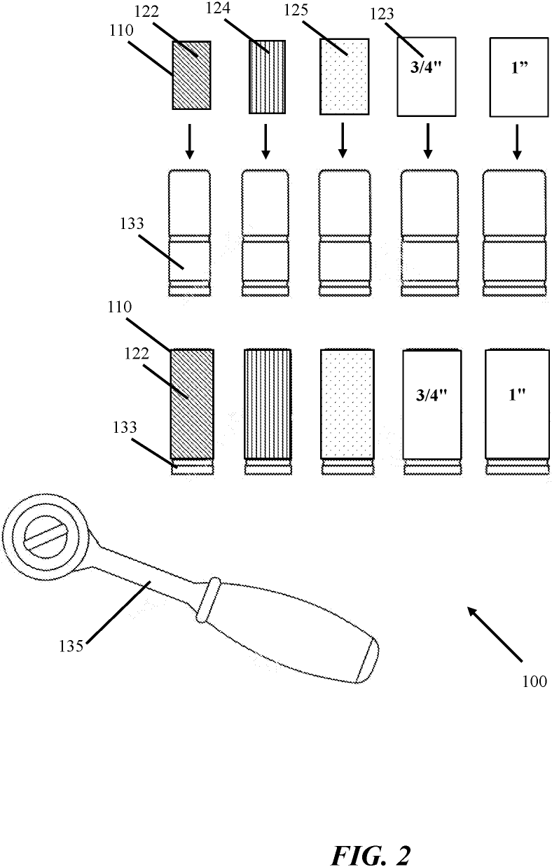

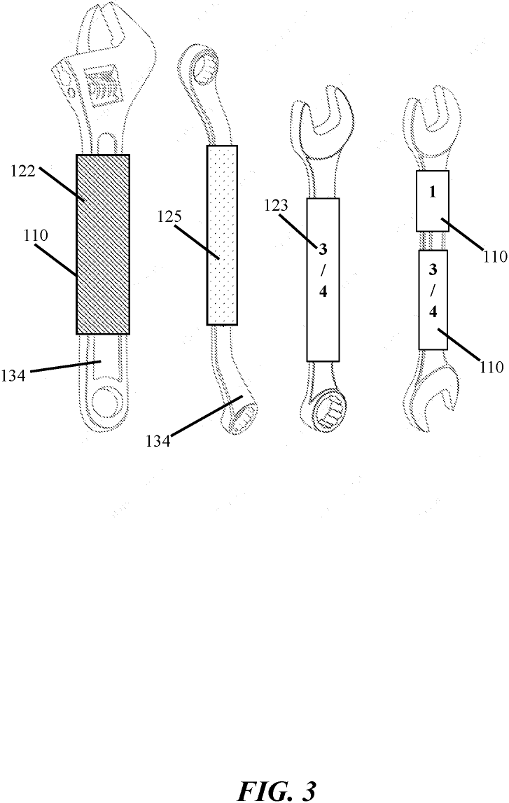

As shown in FIGS. 1-4, the discriminator 122 may include an indicium 123, a color 124, a texture 125, and combinations thereof. Each sleeve 110 may be a different diameter, length, and/or a size for accepting a differently sized tool 132. The tool 132 may include a socket 133 for fitting onto a ratchet handle 135, a wrench 134, or other appropriately desired tool. In certain embodiments, each sleeve 110 may be manufactured using polyethylene terephthalate glycol, polyvinyl chloride, and combinations thereof. In certain embodiments, such as shown in FIG. 3, a tool 132, such as a wrench 134 may include more than one sleeve 110, for example where the wrench 134 includes more than one and/or differently sized wrench head.

Each tool 132 may include a geometric parameter unique to that tool. For example, the tool 132 may include a socket 133, a wrench 134, and or other appropriately desired tool 132 and/or shape of tool 132. The geometric parameter may relate to the size of a fastener or object to which the tool is configured to engage. For example, a socket set may have recesses configured to engage hexagonal fastener head sizes of 9 mm, 10 mm, 11 mm, 12 mm, 13 mm, 14 mm, 15 mm, 16 mm, 17 mm, 18 mm, and 19 mm. The tool 132 may be configured to accept an appropriately desired work piece. For example, the tool 132 may be configured to engage a metric work piece or an imperial work piece.

The sleeve 110 may be heat shrunk onto the tool 132. Certain embodiments include where the sleeve 110 loosely fits over a portion of the tool 132 and is then treated with hot air (e.g., heat gun) that causes the sleeve 110 to shrink and form around the shape of the portion of the tool 132. In particular, the sleeve 110 may be placed onto the tool 132 and heated, such that the sleeve 110 is tightly held on the tool 132. It is also possible for the sleeve 110 to be stretched over a portion of the tool 132 and then heated, where the sleeve 110 tightens and loses its ability to stretch.

In certain embodiments, such as described above, the sleeve 110 may include a discriminator 122 that is unique to the sleeve 110. The discriminator 122 may include an indicium 123, a color 124, and/or a texture 125 or other discriminator 122 that may indicate a feature and/or a size of the tool. For example, a color of the sleeve 110 may indicate whether the tool 132 is a metric or an imperial sized tool and an indicium 123 of the sleeve 110 may indicate the size of the tool 132. In particular, the discriminator 122 may include any appropriately desired characteristic or feature of the tool 132, for enabling a user to quickly identify the tool 132.

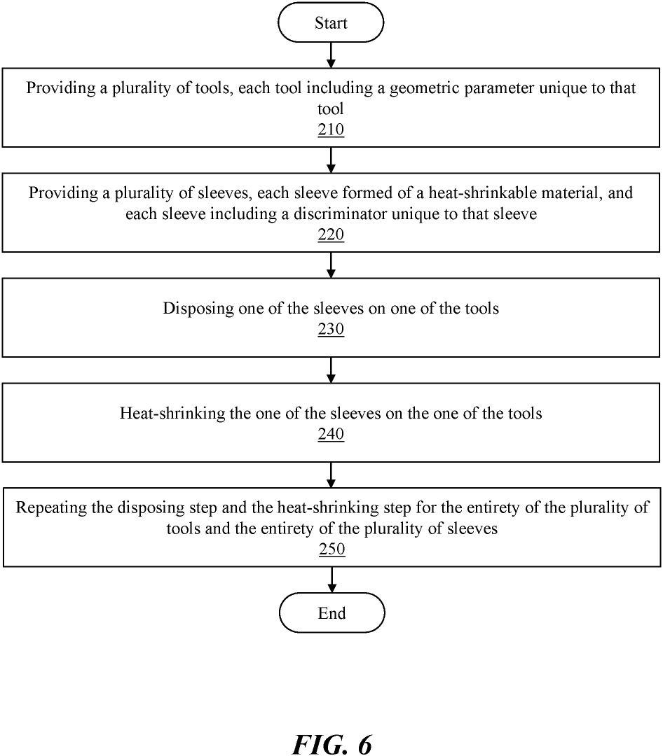

FIG. 6 is a flowchart showing a method of organizing a set of tools 132. At step 210, a plurality of tools may be provided. Each tool 132 may include a geometric parameter unique to that tool 132. At step 220, the method may include providing a plurality of sleeves 110. Each sleeve 110 may be formed of a heat-shrinkable or other suitable material. Each sleeve 110 may include a discriminator 122 unique to the sleeve 110 for identifying tool 132. At step 230, the method may further include disposing a sleeve 110 onto a tool 132. Then, at step 240, the sleeve may be heat-shrunk on one of the tools. At step 250, the method may include repeating the disposing step and the heat-shrinking step for the entirety of a plurality of tools 132 and an entirety of the plurality of sleeves 110.

The disposing step and the heat-shrinking step may be repeated for the entirety of the plurality of tools and the entirety of the plurality of sleeves. In certain embodiments, the sleeves may be disposed onto the plurality of tools and heat-shrunk in a sequential manner. Alternatively, or in conjunction, multiple or the entirety of the sleeves may first be disposed onto the plurality of the tools and then the multiple or the entirety of the sleeves heat-shrunk in batch.

In certain embodiments, the disposing step may include disposing two of the sleeves on one of the tools and the heat-shrinking step may include heating-shrinking the two sleeves on the tool. The method may further include removing a first sleeve from a chain before heating the first sleeve and removing a second sleeve from the chain before heating the second sleeve.

A set of sleeves, such as shrink wrap sleeves may be brightly color coded. Additionally, large contrasting lettering may be used on the tool set. The sleeves may also be textured and untextured. Texturing, for example, may allow a user to reach into a container, such as a toolbox, and identify a particular tool by feel alone. A shrink wrap sleeve may be slid over the handle of a tool and heated to form to the shape of the tool handle. Varying colors and textures of sleeves may allow a user to quickly identify a tool and also clean up the appearance of the tool set. A sleeve may be used to create a shrink wrap sleeve organizational system in which indicium, colors, and textures of the shrink wrap sleeve allows the user to quickly identify each tool or tool family. The sleeves may also provide an improved gripping surface, including where the tool and sleeve may come into contact with fluids, such as oil, grease, or various cleaners.

In certain embodiments, the method may also include removing a first sleeve from a chain before heating the first sleeve and removing a second sleeve from the chain before heating the second sleeve.

Example embodiments are provided so that this disclosure will be thorough, and will fully convey the scope to those who are skilled in the art. Numerous specific details are set forth such as examples of specific components, devices, and methods to provide a thorough understanding of the embodiments of the present disclosure. It will be apparent to those skilled in the art that specific details need to be employed, that example embodiments may be embodied in many different forms, and that neither should be construed to limit the scope of the disclosure. In some example embodiments, well-known processes, well-known device structures and well-known technologies are not described in detail. Equivalent changes, modifications, and variations of some embodiments, materials, compositions, and methods may be made within the scope of the present technology, with substantially similar results.

What is claimed is:

1. A system for organizing a set of tools, the system comprising:
a plurality of sleeves, each sleeve formed of a heat-shrinkable material, and each sleeve including a discriminator unique to that sleeve.

2. The system of claim 1, wherein the discriminator includes a member selected from a group consisting of an indicium, a color, a texture, and combinations thereof.

3. The system of claim 1, wherein the discriminator includes an indicium.

4. The system of claim 1, wherein the discriminator includes a color.

5. The system of claim 1, wherein the discriminator includes a texture.

6. The system of claim 1, wherein each sleeve has a diameter greater than a length thereof.

7. The system of claim 1, wherein each sleeve has a diameter less than a length thereof.

8. The system of claim 1, wherein each sleeve has a diameter substantially equal to a length thereof.

9. The system of claim 1, wherein the plurality of sleeves includes different sized sleeves.

10. The system of claim 1, wherein the plurality of sleeves includes sleeves having different diameters.

11. The system of claim 1, wherein the plurality of sleeves includes sleeves having different lengths.

12. The system of claim 1, wherein the plurality of sleeves is coupled to a chain.

13. The system of claim 12, wherein each sleeve depends from the chain and is co-formed with the chain.

14. The system of claim 12, wherein the plurality of sleeves is formed as a continuous tube, the continuous tube including sleeve defining elements bounding each of the sleeves, each sleeve defining element including a member selected from a group consisting of an indicium, a texture, a precut, perforations, and combinations thereof.

15. A set of tools comprising:
a plurality of tools, each tool including a geometric parameter unique to that tool, each tool including a heat-shrunk sleeve disposed thereon, the heat-shrunk sleeve including a discriminator unique to that sleeve.

16. The set of tools of claim 15, wherein at least one of the tools includes more than one heat-shrunk sleeve disposed thereon.

17. The set of tools of claim 15, wherein the set of tools includes a member selected from a group consisting of: a set of sockets, a set of wrenches, a set of hand tools.

18. A method of organizing a set of tools, comprising:
providing a plurality of tools, each tool including a geometric parameter unique to that tool;
providing a plurality of sleeves, each sleeve formed of a heat-shrinkable material, and each sleeve including a discriminator unique to that sleeve; and
disposing one of the sleeves on one of the tools;
heat-shrinking the one of the sleeves on the one of the tools; and
repeating the disposing step and the heat-shrinking step for an entirety of the plurality of tools and an entirety of the plurality of sleeves.

19. The method of claim 18, wherein the disposing step includes disposing two of the sleeves on the one of the tools and the heat-shrinking step includes heating-shrinking the two of the sleeves on the one of the tools.

20. The method of claim 19, further comprising removing a first sleeve from a chain before disposing the first sleeve on one of the tools and removing a second sleeve from the chain before disposing the second sleeve onto a second one of the tools.
